(19) United States
(12) Patent Application Publication
(10) Pub. No.: US 2024/0349370 A1
(43) Pub. Date: Oct. 17, 2024

(54) METHOD FOR CAPTURING CONTROL AND RELATED APPARATUS

(71) Applicant: AAC ACOUSTIC TECHNOLOGIES (SHENZHEN) CO., LTD., Shenzhen (CN)

(72) Inventor: Zhijiang Wu, Shenzhen (CN)

(21) Appl. No.: 18/650,105

(22) Filed: Apr. 30, 2024

Related U.S. Application Data
(63) Continuation of application No. PCT/CN2023/106142, filed on Jul. 6, 2023.

(30) Foreign Application Priority Data
Apr. 11, 2023 (CN) 202310419291.7

(51) Int. Cl. H04W 76/14; H04N 23/66; H04W 72/40

(52) U.S. Cl. CPC H04W 76/14; H04N 23/66; H04W 72/40

(57) ABSTRACT

Provided is a method for capturing control and a related apparatus. A Bluetooth earphone case is provided with a capturing module and a communication module. Firstly, a target communication connection is established with a terminal device based on the communication module. Then, a capturing control instruction sent by the terminal device is received based on the target communication connection. Next, the capturing module is controlled to trigger a corresponding image capturing state. Finally, a target captured image is sent to the terminal device based on the target communication connection. The terminal device may control the capturing module on the Bluetooth earphone case to realize a capturing function, that is, the terminal device is provided with the capturing function and capturing performance support by expanding the capturing function of the Bluetooth earphone case, which satisfies a capturing requirement of a terminal user and ensure miniaturization of the terminal device.

### TECHNICAL FIELD

The present disclosure relates to the technical field of imaging control, and in particular, to a method for capturing control and a related apparatus.

### BACKGROUND

With the continuous development of the information times, a user has capturing requirements for pictures or videos in more and more scenes. In the related art, a mobile terminal such as a mobile phone and a tablet computer is provided with a camera to satisfy the user's capturing requirements.

At present, requirements for capturing functions expected by users are increasingly diversified and extreme. If capturing functions satisfying the requirements of the users are provided relying on cameras configured on the mobile terminal, more and more cameras would be required to be configured on the mobile terminal, and the sizes of the cameras would become larger and larger. In this case, it is not conducive to miniaturization of the device. As can be seen, it is difficult for the current solution for terminal capturing to achieve a compromise between miniaturization and capturing performance of the device.

### SUMMARY

An objective of the present disclosure is to provide a method for capturing control and a related apparatus, which can solve at least the problem in the related art that it is difficult to achieve a compromise between miniaturization and capturing performance of the device due to the fact that capturing functions are provided relying on the cameras configured on the mobile terminal.

In a first aspect, an embodiment of the present disclosure provides a method for capturing control, which is applied to a Bluetooth earphone case. The Bluetooth earphone case is provided with a capturing module and a communication module. The method for capturing control includes the following steps.

A target communication connection with a terminal device is established based on the communication module.

A capturing control instruction sent by the terminal device is received based on the target communication connection.

The capturing module is controlled to trigger a corresponding image capturing state according to the capturing control instruction. The image includes a video or a picture.

A target captured image is sent to the terminal device based on the target communication connection.

In a second aspect, an embodiment of the present disclosure provides a method for capturing control, which is applied to a terminal device. The method for capturing control includes the following steps.

A target communication connection is established with the Bluetooth earphone case based on a communication connection manner corresponding to a communication module arranged in the Bluetooth earphone case.

A capturing control instruction is sent to the Bluetooth earphone case based on the target communication connection. The capturing control instruction is used to instruct the capturing module arranged in the Bluetooth earphone case to trigger a corresponding image capturing state.

A target captured image sent by the Bluetooth earphone case is received based on the target communication connection.

In a third aspect, an embodiment of the present disclosure provides a Bluetooth earphone case, including a communication module, a capturing module, a first memory, and a first processor. The communication module is configured to establish a target communication connection; the capturing module is configured to collect a target captured image; the first processor is configured to execute a first computer program stored in the first memory; and the first processor, when executing the first computer program, implements steps in the method for capturing control according to the first aspect of the embodiments of the present disclosure.

In a fourth aspect, an embodiment of the present disclosure provides a terminal device, including a second memory and a second processor. The second processor is configured to execute a second computer program stored in the second memory; and the second processor, when executing the second computer program, implements the steps in the method for capturing control according to the second aspect of the embodiments of the present disclosure.

In a fifth aspect, an embodiment of the present disclosure further provides a computer-readable storage medium, storing a first computer program and/or a second computer program. When the first computer program is executed by a processor, steps in the method for capturing control in the first aspect of the embodiments of the present disclosure are implemented, and the processor, when executing the second computer program implements the steps in the method for capturing control in the second aspect of the embodiments of the present disclosure.

As can be seen, according to the method for capturing control and the related apparatus according to the embodiments of the present disclosure, a Bluetooth earphone case is provided with a capturing module and a communication module. Firstly, a target communication connection is established with a terminal device based on the communication module. Then, a capturing control instruction sent by the terminal device is received based on the target communication connection. Next, according to the capturing control instruction, the capturing module is controlled to trigger a corresponding image capturing state. Finally, a target captured image is sent to the terminal device based on the target communication connection. Through implementation of the present disclosure, the terminal device may control the capturing module on the Bluetooth earphone case to realize a capturing function, that is, the capturing function and capturing performance support is provided for the terminal device by expanding the capturing function of the Bluetooth earphone case, which can satisfy a capturing requirement of a terminal user and ensure miniaturization of the terminal device.

### BRIEF DESCRIPTION OF DRAWINGS

FIG. 1 is a schematic structural diagram of a Bluetooth earphone case according to a first embodiment of the present disclosure;

FIG. 2 is a schematic diagram of a basic flowchart of a method for capturing control applied to a side of a Bluetooth earphone case according to the first embodiment of the present disclosure;

FIG. 3 is a schematic diagram of a basic flowchart of a method for capturing control applied to a side of a terminal device according to the first embodiment of the present disclosure;

FIG. 4 is a schematic diagram of signaling interaction of a refined method for capturing control according to a second embodiment of the present disclosure;

FIG. 5 is a schematic diagram of functional modules of a Bluetooth earphone case according to a third embodiment of the present disclosure;

FIG. 6 is a schematic structural diagram of a Bluetooth earphone case according to the third embodiment of the present disclosure; and

FIG. 7 is a schematic diagram of functional modules of a terminal device according to the third embodiment of the present disclosure.

### DESCRIPTION OF EMBODIMENTS

In order to make the invention objectives, features, and advantages of the present disclosure more apparent and comprehensible, the technical solutions in the embodiments of the present disclosure are clearly and completely described below with reference to the accompanying drawings in the embodiments of the present disclosure. Apparently, the embodiments described herein are merely some of, rather than all of, the embodiments of the present disclosure. Based on the embodiments in the present disclosure, all other embodiments obtained by those skilled in the art without any creative effort shall fall within the protection scope of the present disclosure.

In the description of the embodiments of the present disclosure, it should be understood that the orientation or position relationships indicated by the terms “length”, “width”, “upper”, “lower”, “front”, “back”, “left”, “right”, “vertical”, “horizontal”, “top”, “bottom”, “inner”, “outer”, and the like are based on the orientation or position relationships shown in the accompanying drawings and are just intended to facilitate the description of the embodiments of the present disclosure and simplify the description, rather than indicating or implying that the apparatus or element referred to must have a particular orientation or be constructed and operated in the particular orientation, and therefore are not to be interpreted as limitations to the present disclosure.

In addition, the terms “first” and “second” are merely used for descriptive purposes, but not be construed as indicating or implying a relative importance, or implicitly specifying the quantity of the indicated technical features. Therefore, the features defined with “first” and “second” may explicitly or implicitly include one or more of the features. In the description of the embodiments of the present disclosure, “a plurality of” means two or more, unless specifically stated otherwise.

In the embodiments of the present disclosure, unless specifically stated and defined, the terms “mount,” “join,” “connect”, and “fix” should be understood in a broad sense, for example, as a fixed connection, a detachable connection, or an integral connection; a mechanical connection or an electrical connection; a direct connection, an indirect connection through an intermediate medium, an internal connection between two elements, or interaction between two elements. For those of ordinary skill in the art, the specific meanings of the foregoing terms in the embodiments of the present disclosure may be understood based on the specific conditions.

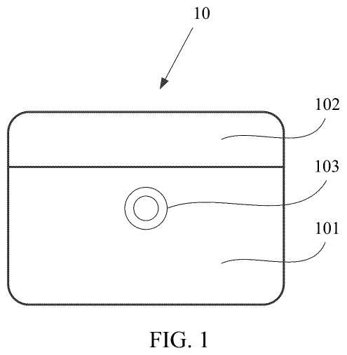

In order to solve the problem in the related art that it is difficult to achieve a compromise between miniaturization and capturing performance of the device due to the fact that capturing functions are provided relying on the cameras configured on the mobile terminal, a first embodiment of the present disclosure provides a method for capturing control, applied to a Bluetooth earphone case, also called a Bluetooth earphone charging case, in which a Bluetooth earphone charging chamber is configured. As an improvement, the Bluetooth earphone case is a TWS Bluetooth earphone case. The Bluetooth earphone case is provided with a capturing module and a communication module. The capturing module is also a camera module and configured to collect image signals. In this embodiment, one or more capturing modules may be provided. If a plurality of capturing modules are provided, types thereof may not be limited to a single type. In practical applications, the type of the capturing module may include, but is not limited to, at least one of the followings: a standard camera module, a wide-angle camera module, a telephoto camera module, a macro camera module, a fisheye camera module, and a tilt-shift camera module. For example, FIG. 1 is a schematic structural diagram of a Bluetooth earphone case exemplarily according to this embodiment. A body of the Bluetooth earphone case 10 may include a case body 101 and a cover body 102. A capturing module 103 may be fixedly arranged on the case body 101. In addition, the communication module in this embodiment may be a wired communication module or a wireless communication module, which is optionally implemented using the wireless communication module. In practical applications, the Bluetooth earphone case may be provided with at least one communication module. The type of the wireless communication module includes, but is not limited to, WiFi, Bluetooth, ZigBee, LPWAN, and 2/3/4/5G.

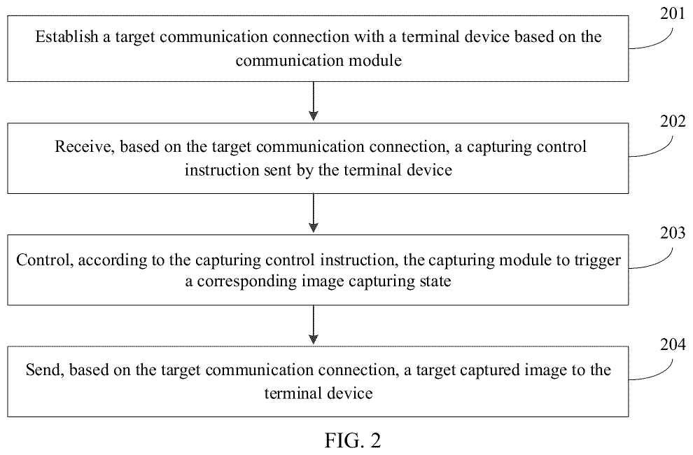

FIG. 2 is a basic flowchart of a method for capturing control applied to a side of a Bluetooth earphone case according to this embodiment. The method for capturing control includes the following steps.

In step 201, a target communication connection is established with a terminal device based on the communication module.

In practical applications, the terminal device may be a mobile terminal held by a user, such as a mobile phone or a tablet computer, or may be a fixed terminal such as a personal computer. The terminal device generally supports multiple communication manners. The Bluetooth earphone case in this embodiment may establish the communication connection with the terminal device by any feasible manner, which is not uniquely limited in this embodiment.

In some implementations of this embodiment, the communication module includes a Bluetooth module and a WiFi module. Correspondingly, said establishing the target communication connection with the terminal device based on the communication module includes the following steps: triggering, based on a first operational instruction, the Bluetooth module to receive a Bluetooth broadcast signal of the terminal device and establish a Bluetooth communication connection with the terminal device; sending a hotspot sharing request to the terminal device based on the Bluetooth communication connection, the hotspot sharing request being used to request the terminal device to enable a hotspot sharing state; and triggering, based on a second operational instruction, the WiFi module to access a WiFi network shared by the terminal device and establish a target communication connection with the terminal device.

In this embodiment, the Bluetooth earphone case is provided with both a Bluetooth module and a WiFi module. In this embodiment, the Bluetooth module has relatively poor communication transmission performance and cannot satisfy a high-bit-rate data transmission requirement and a high-response data control requirement. In this case, in this embodiment, after finding a Bluetooth broadcast signal of the terminal device through the Bluetooth module, the Bluetooth earphone case pairs with the terminal device and establishes a Bluetooth communication connection, and then requests, based on the established Bluetooth communication connection, the terminal device to share a hotspot. After the terminal device enables the hotspot, the Bluetooth earphone case can access a hotspot network shared by the terminal device, through the WiFi module provided at the Bluetooth earphone case itself, that is, a WiFi network, thereby establishing a WiFi connection with the terminal device. Accordingly, better communication transmission performance can be achieved during the capturing control, and immediacy of data transmission and data control responses can be ensured.

Referring to FIG. 1 again, in some implementations of this embodiment, the Bluetooth earphone case 10 includes a case body 101 and a cover body 102, and the cover body 102 covers the case body 101. Correspondingly, prior to the step of triggering, based on a second operational instruction, the WiFi module to access a WiFi network shared by the terminal device, the method further includes: detecting a real-time state of the cover body relative to the case body; triggering the first operational instruction if the real-time state switches from a closed state to an open state; and triggering the second operational instruction if the real-time state switches from the open state to the closed state.

In this embodiment, when the Bluetooth earphone case is in an initial state, the cover body is in the closed state. When requiring a capturing control, the user may manually open the cover body to cause the cover body to arrive at the open state, such that the Bluetooth earphone case is triggered to establish a Bluetooth communication connection with the terminal device through the Bluetooth module and send a hotspot sharing request to the terminal device. Next, after the user closes the cover body, the cover body switches from the open state to the original closed state, further triggering the WiFi module of the Bluetooth earphone case to access the hotspot shared by the terminal device to complete the WiFi communication connection with the terminal device, that is, the target communication connection in this embodiment.

In step 202, a capturing control instruction sent by the terminal device is received based on the target communication connection.

In this embodiment, after the Bluetooth earphone case successfully establishes a communication connection with the terminal device, the user inputs a capturing control instruction to the terminal device, and the terminal device sends the capturing control instruction to the Bluetooth earphone case to perform a corresponding control action on the capturing module of the Bluetooth earphone case. It should be understood that the capturing control instruction in this embodiment may include, but is not limited to, any one of the following: a capturing start instruction, a continuous capturing instruction, a capturing stop instruction, and the like.

In step 203, according to the capturing control instruction, the capturing module is controlled to trigger a corresponding image capturing state.

In this embodiment, after receiving an image capturing instruction sent by the terminal device, the Bluetooth earphone case may perform image capturing control on the capturing module. The images referred to in this embodiment include videos or pictures. The image capturing state includes an image capturing start state, a continuous picture capturing state, and an image capturing stop state.

In some implementations of this embodiment, the capturing module includes a plurality of cameras. Correspondingly, the step of controlling, according to the capturing control instruction, the capturing module to trigger a corresponding image capturing state includes: acquiring a capturing mode associated with the capturing control instruction; and controlling, according to the capturing mode, a target camera in the capturing module to trigger an image capturing state corresponding to the capturing control instruction.

In this embodiment, the capturing module in this embodiment includes a plurality of cameras, so as to satisfy more diversified and complex capturing requirements. The plurality of cameras may have the same or different types. In practical applications, the capturing module may operate in different capturing modes. When the terminal device sends a capturing control instruction, the capturing control instruction may carry capturing mode indication information. An indicated capturing mode may include a portrait capturing mode, a landscape capturing mode, a sport capturing mode, a macro capturing mode, a night capturing mode, and the like. Therefore, the Bluetooth earphone case may determine, according to the indicated capturing mode, the target camera to be triggered in the capturing module, and then perform image capturing control on the target camera.

Further, in some implementations of this embodiment, the capturing module includes a plurality of target cameras with different orientations and optical axes on a same plane. As an improvement, the step of controlling, according to the capturing mode, a target camera in the capturing module to trigger an image capturing state corresponding to the capturing control instruction includes: controlling, in response to the capturing mode being a panoramic capturing mode, all the target cameras in the capturing module to simultaneously trigger the image capturing state corresponding to the capturing control instruction.

Current terminal devices generally use a single camera for imaging, but the single camera has a problem that the viewing angle is narrow. In order to break through the limitations of the narrow viewing angle of the single camera, those skilled in the art have developed a single-camera panoramic mode. When the user uses the single camera for panoramic capturing, the terminal device generally needs to be moved by a preset angle range to continuously capture a plurality of pictures and then stitch the images to obtain a panoramic picture, such that the operation is complicated, and the stability of the capturing operation is difficult to be guaranteed, resulting in relatively poor imaging quality.

Based on this, the capturing module in this embodiment includes a plurality of cameras with different orientations and optical axes on a same plane arranged on the Bluetooth earphone case. Each of the cameras is responsible for captured images in different regions, and adjacent cameras have some capturing regions overlapping each other. As an improvement, in this embodiment, four panoramic cameras are provided. The four cameras are respectively arranged in four directions of the headphone box, namely front, rear, left, and right. A sum of viewing angles of all the cameras is greater than or equal to 360 degrees. When the Bluetooth earphone case receives a panoramic capturing control instruction, a panoramic image may be directly captured by a plurality of cameras, resulting in convenient operation and higher imaging quality. It should be noted that, in this embodiment, after all cameras that perform panoramic capturing capture a plurality of pictures, overlapped picture regions of the pictures corresponding to adjacent cameras are acquired, and then a transformation matrix between the corresponding images is solved for the overlapped picture regions. Finally, the corresponding images are mapped and transformed based on the transformation matrix, to obtain a stitched picture, that is, a panoramic picture.

Further, in some other implementations of this embodiment, the capturing module includes a plurality of cameras of different types. Correspondingly, the step of controlling, according to the capturing mode, a target camera in the capturing module to trigger an image capturing state corresponding to the capturing control instruction includes: acquiring a camera type and a camera configuration parameter associated with the capturing mode; configuring, according to the camera configuration parameter, an operating parameter of a target camera corresponding to the camera type; and controlling, after completing the configuration of the operating parameter, the target camera to trigger the image capturing state corresponding to the capturing control instruction.

As an improvement, the capturing mode in this embodiment may include a primary capturing mode and a secondary capturing mode. The primary capturing mode is a superior capturing mode of the secondary capturing mode. For example, if the primary capturing mode is a portrait capturing mode, the secondary capturing mode may be a child capturing mode. In practical applications, a subdivided capturing mode has different imaging effect requirements. Based on this, in this embodiment, a specific camera is associated with according to the superior capturing mode in the capturing mode, that is, the primary capturing mode, a configuration parameter of the camera is further determined according to the subdivided capturing mode, that is, the secondary capturing mode, and adapted to a capturing scene corresponding to the secondary capturing mode, and an operating parameter of the camera is configured according to the configuration parameter, which realizes refined capturing control over the Bluetooth earphone case by the terminal device and can satisfy more diversified and complex capturing requirements.

In step 204, a target captured image is sent to the terminal device based on the target communication connection.

In this embodiment, the target captured image may be a preview image or a captured image. The Bluetooth earphone case may automatically upload the target captured image to the terminal device in real time, or upload the target captured image of the Bluetooth earphone case to the terminal device at any specific moment according to a manual operation, which is not uniquely limited in this embodiment.

In some implementations of this embodiment, the Bluetooth earphone case is further provided with a memory unit. Correspondingly, prior to the step of sending the target captured image to the terminal device, the method further includes: determining whether the target captured image satisfies a preset privacy storage condition; if the privacy storage condition is satisfied, storing the target captured image in the memory unit, and generating a privacy image tag corresponding to the target captured image; sending, based on the target communication connection, the privacy image tag to the terminal device; performing, when access verification information corresponding to the privacy image tag sent by the terminal device is received, validity verification on the access verification information; and calling, if the verification is passed, the target captured image stored in the memory unit, and then performing the step of sending the target captured image to the terminal device.

In this embodiment, pictures or videos taken by the user are generally stored in a photo album application in the terminal device. Any user using the terminal device may view information of the pictures or videos in the photo album application. However, the pictures or videos stored by an owner of the terminal device may involve privacy information. If the terminal device is used by others, there is a risk that privacy pictures or videos may be leaked, resulting in that the user's privacy information cannot be fully protected. Based on this, in this embodiment, after completing the capturing, the Bluetooth earphone case does not directly upload the target captured image to the terminal device, but first determines whether the target captured image satisfies the privacy storage condition, for example, performs picture recognition on the target captured image to determine whether the image includes privacy information, or determines whether the capturing control instruction sent by the terminal device carries a privacy capturing tag. If the privacy storage condition is satisfied, it indicates that the target captured image is a privacy image. The Bluetooth earphone case stores the target captured image in the memory unit configured in the Bluetooth earphone case itself and generates the corresponding privacy image tag. Next, only the privacy image tag is uploaded to the terminal device. It should be understood that the privacy image tag in this embodiment may include basic information of the target captured image, such as a capturing time, a capturing location, and the like, to assist the user in identifying the target captured image. Then, if the user needs to view the privacy image, the access verification information corresponding to the privacy image tag may be triggered on the terminal device, such as an access password, and the Bluetooth earphone case performs validity verification on the access verification information. If the verification is passed, it is determined that a privacy image access request is initiated by the owner of the terminal device, and then a requested privacy image is uploaded to the terminal device. Therefore, the user's privacy image information can be effectively protected.

In addition, as an improvement, the step of generating a privacy image tag corresponding to the target captured image includes: identifying a privacy picture region of a feature picture corresponding to the target captured image; blurring the privacy picture region to obtain a first picture; and performing thumbnail processing on the first picture to obtain the privacy image tag corresponding to the target captured image.

In this embodiment, if the type of the target captured image is a picture, the feature picture is the captured picture itself. If the type of the target image is a video, the feature picture may be a certain frame in the video. The privacy image tag in this embodiment may further include a thumbnail picture of the target captured image that has been processed for privacy protection. The user is prompted with information of the target captured image in a form of a picture, which can assist the user in identifying the target captured image more effectively, compared with simple text information.

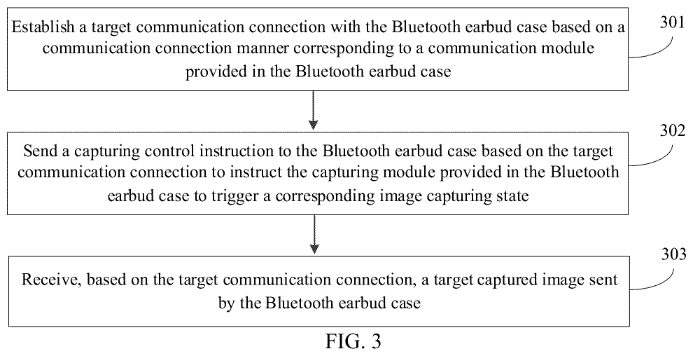

In addition, this embodiment further adaptively provides a method for capturing control applied to a terminal device. FIG. 3 is a basic flowchart of a method for capturing control applied to a side of a terminal device according to this embodiment. The method for capturing control includes the following steps.

In step 301, a target communication connection is established with the Bluetooth earphone case based on a communication connection manner corresponding to a communication module arranged in the Bluetooth earphone case.

In step 302, a capturing control instruction is sent to the Bluetooth earphone case based on the target communication connection to instruct the capturing module arranged in the Bluetooth earphone case to trigger a corresponding image capturing state.

In step 303, a target captured image sent by the Bluetooth earphone case is received based on the target communication connection.

In this embodiment, the terminal device may establish a communication connection with the Bluetooth earphone case in a communication connection manner such as Bluetooth or WiFi. Then, the user may trigger a capturing control operation on the terminal device, and the terminal device sends a capturing control instruction to the Bluetooth earphone case accordingly to perform capturing control over the capturing module configured on the Bluetooth earphone case and acquire a captured image fed back by the Bluetooth earphone case.

It is to be noted that the terminal device in this embodiment may achieve picture or video capturing by means of an external device, without relying on configuration of its own capturing module. Therefore, when the terminal device is not configured with a capturing module or the configured capturing module has limited performance, the capturing function can be expanded through the Bluetooth earphone case of this embodiment, which is conducive to miniaturization of the terminal device and effectively expands capturing performance of the terminal device.

Compared with the related art, according to the method for capturing control according to this embodiment, a Bluetooth earphone case is provided with a capturing module and a communication module. Firstly, a target communication connection is established with a terminal device based on the communication module. Then, a capturing control instruction sent by the terminal device is received based on the target communication connection. Next, according to the capturing control instruction, the capturing module is controlled to trigger a corresponding image capturing state. Finally, a target captured image is sent to the terminal device based on the target communication connection. Through implementation of the present disclosure, the terminal device may control the capturing module on the Bluetooth earphone case to realize a capturing function, that is, the capturing function and capturing performance support is provided for the terminal device by expanding the capturing function of the Bluetooth earphone case, which can satisfy a capturing requirement of a terminal user and ensure miniaturization of the terminal device.

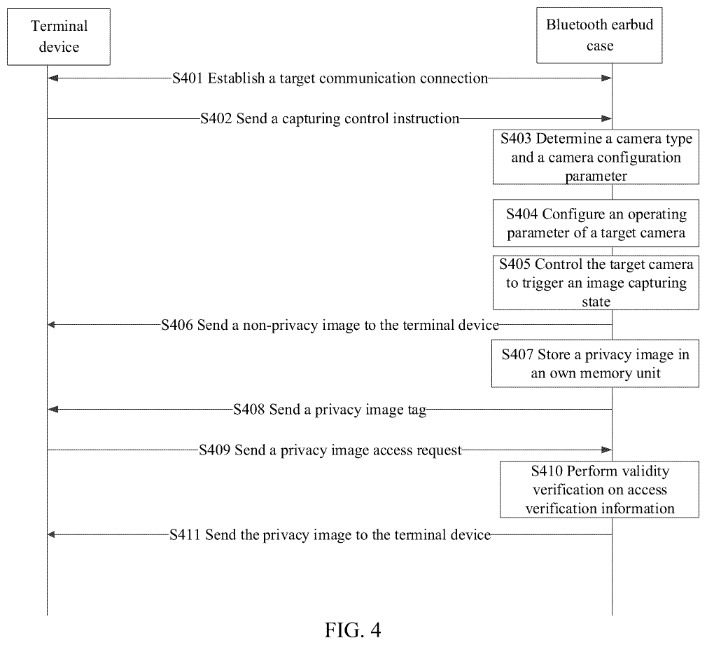

FIG. 4 is a schematic diagram of signaling interaction of a refined method for capturing control according to a second embodiment of the present disclosure, applied to a capturing control system including a terminal device and a Bluetooth earphone case. The method for capturing control includes the following steps.

In step 401, the terminal device establishes a target communication connection with the Bluetooth earphone case based on a communication connection manner corresponding to a communication module arranged in the Bluetooth earphone case.

In step 402, the terminal device sends a capturing control instruction to the Bluetooth earphone case based on the target communication connection.

In step 403, the Bluetooth earphone case determines a camera type and a camera configuration parameter according to a capturing mode associated with the capturing control instruction.

In step 404, the Bluetooth earphone case configures, according to the camera configuration parameter, an operating parameter of a target camera corresponding to the camera type.

In step 405, the Bluetooth earphone case controls, after the configuration of the operating parameter, the target camera to trigger the image capturing state corresponding to the capturing control instruction.

In step 406, when the target captured image is a non-privacy image, the Bluetooth earphone case sends the non-privacy image to the terminal device.

In step 407, when the target captured image is a privacy image, the Bluetooth earphone case stores the privacy image in its own memory unit.

In step 408, the Bluetooth earphone case sends a privacy image tag to the terminal device.

In step 409, the terminal device sends a privacy image access request to the Bluetooth earphone case.

In step 410, the Bluetooth earphone case performs validity verification on access verification information carried in the privacy image access request.

In step 411, the Bluetooth earphone case sends the privacy image to the terminal device when the verification on the access verification information is passed.

It should be understood that, in this embodiment, sequence numbers of the steps do not mean an absolute execution sequence of the steps. The execution sequence of the steps shall be determined based on functions and internal logic thereof, and shall not constitute the unique limitation on the implementation process of the embodiments of the present disclosure.

Compared with the related art, through the implementation of the method for capturing control according to this embodiment, the terminal device may control the capturing module on the Bluetooth earphone case to realize the capturing function, that is, the capturing function and capturing performance support is provided for the terminal device by expanding the capturing function of the Bluetooth earphone case, which can satisfy a capturing requirement of a terminal user and ensure miniaturization of the terminal device. Moreover, the capturing module of the Bluetooth earphone case includes a plurality of cameras. According to a capturing mode, a specific camera may be triggered to operate and an operating parameter thereof may be configured, thereby satisfying diversified and complex capturing requirements. In addition, the privacy image captured by the Bluetooth earphone case may be temporarily stored locally in the Bluetooth earphone case, and validity verification is performed when the terminal device initiates an access request, which can effectively protect privacy image information of the user.

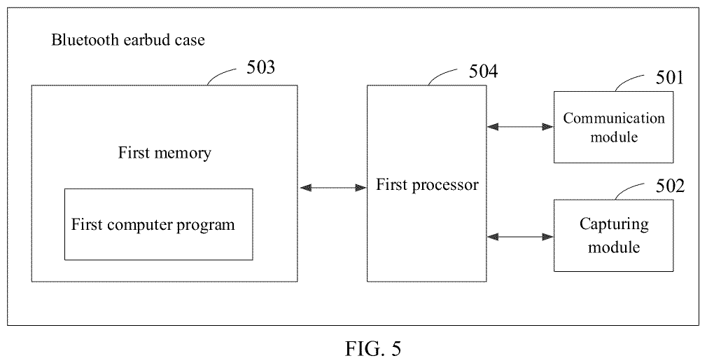

Referring to FIG. 5, FIG. 5 is a schematic diagram of functional modules of a Bluetooth earphone case according to a third embodiment of the present disclosure. The Bluetooth earphone case may be configured to implement the method for capturing control applied to a side of a Bluetooth earphone case in the foregoing embodiment. As shown in FIG. 5, the Bluetooth earphone case mainly includes: a communication module 501, a capturing module 502, a first memory 503, and a first processor 504.

The communication module 501 is configured to establish a target communication connection. The capturing module 502 is configured to collect a target captured image. The first processor 504 is configured to execute a first computer program stored in the first memory 503. The first processor 504, when executing the first computer program, implements the method for capturing control applied to a side of a Bluetooth earphone case in the foregoing embodiment.

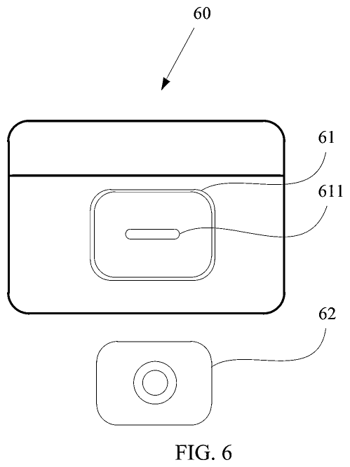

FIG. 6 is a schematic structural diagram of a Bluetooth earphone case according to this embodiment. As an improvement, a body of the Bluetooth earphone case 60 is provided with a module mounting portion 61. The module mounting portion 61 is provided with a control interface 611 electrically connected to the first processor. The capturing module 62 is detachably connected to the module mounting portion 61. When the capturing module 62 is installed in the module mounting portion 61, the capturing module 62 is electrically connected to the control interface 611.

In this embodiment, the Bluetooth earphone case is limited in size, and the quantity and the size of the capturing module that can be carried at one time are relatively limited. In practical applications, the user's capturing requirements may be various, and the capturing module may be damaged or have functions being upgraded during usage. Therefore, it is difficult to satisfy actual requirements of the user by fixing the capturing module. Based on this, the Bluetooth earphone case in this embodiment adopts modular capturing module configuration, and the Bluetooth earphone case is provided with a modular interface, that is, the foregoing control interface. The control interface may be a universal interface that supports electrical connection with a variety of capturing modules. After the capturing module is installed in the module mounting portion, the processor is electrically connected to the capturing module through the control interface, thereby controlling the capturing module.

In addition, it is to be further noted that the module mounting portion in this embodiment may refer to a certain region on the body of the Bluetooth earphone case. Correspondingly, the capturing module may be installed in the module mounting portion by magnetic attraction, or may be a specific physical structure design on the body of the Bluetooth earphone case. Correspondingly, the capturing module may be installed in the module mounting portion by engagement, which is not uniquely limited in this embodiment.

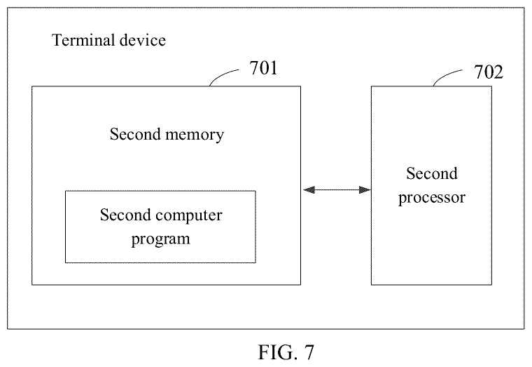

FIG. 7 is a schematic diagram of functional modules of a terminal device according to this embodiment. The terminal device may be configured to implement the method for capturing control applied to a side of a terminal device in the foregoing embodiment. The terminal device includes: a second memory 701 and a second processor 702. The second processor 702 is configured to execute a second computer program stored in the second memory 701. The second processor 702, when executing the computer program, implements the method for capturing control applied to a side of a terminal device in the foregoing embodiments.

It should be noted that, in this embodiment, the memory may be a high-speed random access memory (RAM), or a non-volatile memory, such as a disk memory. The memory may be configured to store executable program code, and the processor is coupled to the memory.

Further, an embodiment of the present disclosure further provides a computer-readable storage medium. The computer-readable storage medium may be arranged in the terminal device or the Bluetooth earphone case according to the above embodiments. The computer-readable storage medium may be the memory according to the embodiment shown in FIG. 5 or FIG. 7.

The computer-readable storage medium stores a computer program. The program, when the program is executed by a processor, implements the method for capturing control in the foregoing embodiments. Further, the computer-readable storage medium may alternatively be any medium that can store program code such as a USB flash disk, a mobile hard disk, a read-only memory (ROM), a RAM, a magnetic disk, or an optical disc.

In the several embodiments according to the present disclosure, it should be understood that the apparatus and method disclosed may be implemented in other manners. For example, the apparatus embodiments described above are only illustrative. For example, the division of the modules is merely logical function division, and there may be other division manners in an actual implementation. For example, a plurality of modules or components may be combined or integrated into another system, or some features may be ignored or not performed. In addition, the shown or discussed mutual couplings, direct couplings or communication connections may be implemented by using some interfaces. The indirect couplings or communication connections between apparatuses or modules may be implemented in an electric form, a mechanical form, or other forms.

The modules described as separate parts may be or may not be physically separated, and the components displayed as modules may be or may not be physical modules, that is, may be located at one position, or may be distributed on a plurality of network modules. Some or all of the modules may be selected to achieve the objective of the solution of this embodiment according to actual requirements.

In addition, the functional modules in the embodiments of the present disclosure may be integrated into one processing module, or each of the modules may exist alone physically, or two or more modules are integrated into one module. The integrated module may be implemented in a form of a hardware or in a form of a software functional module.

The integrated module may be stored in a computer-readable storage medium when implemented in the form of the software functional module and sold or used as a separate product. Based on such an understanding, the technical solutions in the present disclosure essentially, or the part contributing to the prior art, or some of the technical solutions may be implemented in the form of a software product. The computer software product is stored in a readable storage medium, and includes several instructions for causing a computer device (which may be a personal computer, a server, a network device, or the like) to perform all or some of the steps of the methods described in the embodiments of the present disclosure. The foregoing storage medium includes any medium that can store program code, such as a USB flash drive, a removable hard disk, a ROM, a RAM, a magnetic disk, or an optical disc.

It is to be noted that, to make the description brief, the foregoing method embodiments are expressed as a series of actions. However, those skilled in the art should appreciate that the present disclosure is not limited to the described action sequence, since, some steps may be performed in other sequences or performed simultaneously according to the present disclosure. In addition, those skilled in the art should also appreciate that all the embodiments described in the specification are preferred embodiments, and the related actions and modules are not necessarily mandatory to the present disclosure.

In the above embodiments, the descriptions of the embodiments have respective focuses. For a part that is not described in detail in one embodiment, refer to related descriptions in other embodiments.

The above are descriptions about the method for capturing control and the related apparatus according to the present disclosure. For those skilled in the art, there may be changes in specific embodiments and an application scope based on the ideas of the embodiments of the present disclosure. In summary, the content of this specification should not be interpreted as a limitation to the present disclosure.

What is claimed is:

1. A method for capturing control, applied to a Bluetooth earphone case provided with a capturing module and a communication module, comprising:
establishing, based on the communication module, a target communication connection with a terminal device;
receiving, based on the target communication connection, a capturing control instruction sent by the terminal device;
controlling, according to the capturing control instruction, the capturing module to trigger a corresponding image capturing state; wherein the image comprises a video or a picture; and
sending, based on the target communication connection, a target captured image to the terminal device.

2. The method for capturing control as described in claim 1, wherein the communication module comprises a Bluetooth module and a WiFi module; and said establishing, based on the communication module, a target communication connection with a terminal device comprises:
triggering, based on a first operational instruction, the Bluetooth module to receive a Bluetooth broadcast signal of the terminal device and establish a Bluetooth communication connection with the terminal device;
sending, based on the Bluetooth communication connection, a hotspot sharing request to the terminal device; wherein the hotspot sharing request is configured to request the terminal device to enable a hotspot sharing state; and
triggering, based on a second operational instruction, the WiFi module to access a WiFi network shared by the terminal device and establish a target communication connection with the terminal device.

3. The method for capturing control as described in claim 2, wherein the Bluetooth earphone case comprises a case body and a cover body, the cover body covering the case body; and prior to said triggering, based on the second operational instruction, the WiFi module to access the WiFi network shared by the terminal device, the method further comprises:
detecting a real-time state of the cover body relative to the case body;
triggering the first operational instruction in response to the real-time state switching from a closed state to an open state; and
triggering the second operational instruction in response to the real-time state switching from the open state to the closed state.

4. The method for capturing control as described in claim 1, wherein the capturing module comprises a plurality of cameras; and said controlling, according to the capturing control instruction, the capturing module to trigger the corresponding image capturing state comprises:
acquiring a capturing mode associated with the capturing control instruction; and
controlling, according to the capturing mode, a target camera in the capturing module to trigger an image capturing state corresponding to the capturing control instruction.

5. The method for capturing control as described in claim 4, wherein the capturing module comprises a plurality of target cameras with different orientations and optical axes on a same plane; and said controlling, according to the capturing mode, the target camera in the capturing module to trigger the image capturing state corresponding to the capturing control instruction comprises:
controlling, in response to the capturing mode being a panoramic capturing mode, all the target cameras in the capturing module to simultaneously trigger the image capturing state corresponding to the capturing control instruction.

6. The method for capturing control as described in claim 4, wherein the capturing module comprises a plurality of cameras of different types; and said controlling, according to the capturing mode, the target camera in the capturing module to trigger the image capturing state corresponding to the capturing control instruction comprises:
acquiring a camera type and a camera configuration parameter associated with the capturing mode;
configuring, according to the camera configuration parameter, an operating parameter of a target camera corresponding to the camera type; and
controlling, after completing configuring the operating parameter, the target camera to trigger the image capturing state corresponding to the capturing control instruction.

7. The method for capturing control as described in claim 1, wherein the Bluetooth earphone case is further provided with a memory unit; and prior to said sending the target captured image to the terminal device, the method further comprises:
determining whether the target captured image satisfies a preset privacy storage condition;
storing, in response to the privacy storage condition being satisfied, the target captured image in the memory unit, and generating a privacy image tag corresponding to the target captured image;
sending, based on the target communication connection, the privacy image tag to the terminal device;
performing validity verification on the access verification information when access verification information corresponding to the privacy image tag sent by the terminal device is received; and
calling, in response to the verification being passed, the target captured image stored in the memory unit, and performing the step of sending the target captured image to the terminal device.

8. A method for capturing control, applied to a terminal device, comprising:
establishing a target communication connection with a Bluetooth earphone case based on a communication connection manner corresponding to a communication module provided in the Bluetooth earphone case;
sending a capturing control instruction to the Bluetooth earphone case based on the target communication connection; wherein the capturing control instruction is configured to instruct a capturing module provided in the Bluetooth earphone case to trigger a corresponding image capturing state; and
receiving, based on the target communication connection, a target captured image sent by the Bluetooth earphone case.

9. A Bluetooth earphone case, comprising:
a communication module configured to establish a target communication connection;
a capturing module configured to collect a target captured image; and
a first processor configured to execute a first computer program stored in the first memory;
wherein the first processor, when executing the first computer program, implements the steps of the method for capturing control as described in claim 1.

10. The Bluetooth earphone case as described in claim 9, wherein a body of the Bluetooth earphone case is provided with a module mounting portion, the module mounting portion is provided with a control interface electrically connected to the first processor, the capturing module is detachably connected to the module mounting portion, and when the capturing module is installed in the module mounting portion, the capturing module is electrically connected to the control interface.

11. A terminal device, comprising:
a second memory; and
a second processor configured to execute a second computer program stored in the second memory; and
wherein the second processor, when executing the second computer program, implements the steps of the method for capturing control as described in claim 8.

12. A computer-readable storage medium, storing a first computer program and/or a second computer program,
wherein when the first computer program is executed by a processor, a target communication connection is established with a terminal device based on a communication module, a capturing control instruction sent by the terminal device is received based on the target communication connection, a capturing module is controlled to trigger a corresponding image capturing state, according to the capturing control instruction, wherein the image comprises a video or a picture, and a target captured image is sent to the terminal device based on the target communication connection, and/or
wherein when the second computer program is executed by the processor, a target communication connection with a Bluetooth earphone case is established based on a communication connection manner corresponding to a communication module provided in the Bluetooth earphone case, a capturing control instruction is sent to the Bluetooth earphone case based on the target communication connection, wherein the capturing control instruction is configured to instruct a capturing module provided in the Bluetooth earphone case to trigger a corresponding image capturing state; and a target captured image sent by the Bluetooth earphone case is received based on the target communication connection.
